(19) United States
(12) Patent Application Publication
(10) Pub. No.: US 2016/0028342 A1
(43) Pub. Date: Jan. 28, 2016

(54) ELECTRIC MOTOR DRIVE DEVICE

(71) Applicant: Hitachi Automotive Systems, Ltd., Hitachinaka-shi (JP)

(72) Inventors: Kimihisa FURUKAWA, Tokyo (JP); Toshiyuki AJIMA, Tokyo (JP); Tohma YAMAGUCHI, Hitachinaka (JP); Hiroki TAKEDA, Hitachinaka (JP); Nobuhiko OKABE, Hitachinaka (JP)

(73) Assignee: Hitachi Automotive Systems, Ltd., Hitachinaka-shi (JP)

(21) Appl. No.: 14/691,986

(22) Filed: Apr. 21, 2015

(30) Foreign Application Priority Data
Apr. 22, 2014 (JP) 2014-088007

(51) Int. Cl. H02P 29/02; H02P 27/06

(52) U.S. Cl. CPC H02P 29/021; H02P 27/06

(57) ABSTRACT

An electric motor drive device which drives an electric motor includes switching elements which are respectively connected to output lines and correspond to upper and lower arms of respective phases, a control unit which controls the operations of the switching elements, a smoothing capacitor connected in parallel with series circuits of the upper and lower arms of the phases, and an abnormality detection unit. The abnormality detection unit detects a voltage value of a virtual neutral point as a value related to the state of insulation of each of the output lines and detects a ground fault of the output line, based on a tilt of a temporary change in the detected value.

### CLAIM OF PRIORITY

The present application claims priority from Japanese Patent applications serial No.2014-88007, filed on Apr. 22, 2014, the respective contents of which are hereby incorporated by reference into this application.

### FIELD OF THE INVENTION

The present invention relates to an electric motor drive device.

### BACKGROUND OF THE INVENTION

In general, an electric motor drive device for driving and controlling an electric motor is equipped with a power conversion device which generates AC power in response to DC power from a DC power supply, and a control device for controlling the power conversion device. The AC power obtained from the power conversion device is supplied to the electric motor (e.g., three-phase synchronous motor). The electric motor generates rotational torque in accordance with the supplied AC power.

Such an electric motor drive device is used to drive and control various electric motors mounted to, for example, a vehicle. As one example thereof, each of a vehicle electric auxiliary device, and an electric motor drive device used in a vehicle drive electric motor or the like for driving the wheels of a vehicle receives DC power from a secondary battery mounted to the vehicle and converts it into AC power, and supplies the AC power to its corresponding electric motor to thereby drive and control a system device. Since these have been well known, further description thereof is omitted herein.

It has been desired that when a ground fault occurs in each of output lines including electric wirings from switching elements of a power conversion device to an electric motor and windings of the electric motor, an electric motor drive device suitably detects it and safely stops the electric motor and the power conversion device. In order to meet such a demand, there has been described in the Japanese Patent Laid open No. 2007-244104 (hereinafter referred to as Patent Document 1), a technology which detects a voltage across a smoothing capacitor and determines that a ground fault has occurred when an increase in the voltage exceeds a predetermined value, thereby detecting the ground fault.

The technology disclosed in the Patent Document 1 detects a change in the voltage across the smoothing capacitor, which changes in a step form, based on a PWM pulse pattern of the power conversion device, and compares it with a predetermined threshold value, thereby detecting the ground fault of the electric motor. However, a problem arises in that since the change in the voltage across the smoothing capacitor is small where the degree of modulation of PWM is small, it is hard to detect the ground fault.

An object of the present invention is to provide an electric motor drive device capable of accurately detecting a ground fault regardless of the degree of modulation.

### SUMMARY OF THE INVENTION

There is provided an electric motor drive device according to the present invention, which is connected to an electric motor through output lines of respective phases to drive the electric motor. The electric motor drive device is equipped with a plurality of switching elements which are respectively connected to the output lines and correspond to upper and lower arms of the phases, a control unit which controls operations of the switching elements, a smoothing capacitor connected in parallel with series circuits of the upper and lower arms of the phases, and an abnormality detection unit which detects a value related to the state of insulation of each of the output lines and detects a ground fault of the output line, based on a tilt of a temporary change in the detected value.

According to the present invention, it is possible to accurately detect a ground fault regardless of the degree of modulation.

### BRIEF DESCRIPTION OF THE DRAWINGS

FIG. 1 is a diagram showing the configuration of an electric motor drive device according to a first embodiment of the present invention;

FIG. 2 is a circuit diagram showing one example of a ground fault phenomenon;

FIGS. 3(a), 3(b), and 3(c) are a diagram showing the manner of changes in the voltages of a smoothing capacitor and a virtual neutral point at the occurrence of a ground fault;

FIG. 4 is a diagram showing a control flow of abnormality detection processing according to the first embodiment of the present invention;

FIG. 5 is a diagram showing the configuration of an electric motor drive device according to a second embodiment of the present invention; and

FIG. 6 is a diagram showing a control flow of abnormality detection processing according to a third embodiment of the present invention.

### DETAILED DESCRIPTION OF THE PREFERRED EMBODIMENTS

Electric motor drive devices according to preferred embodiments of the present invention will hereinafter be described in detail using the accompanying drawings.

### First Embodiment

### <Configuration of Electric Motor Drive Device>

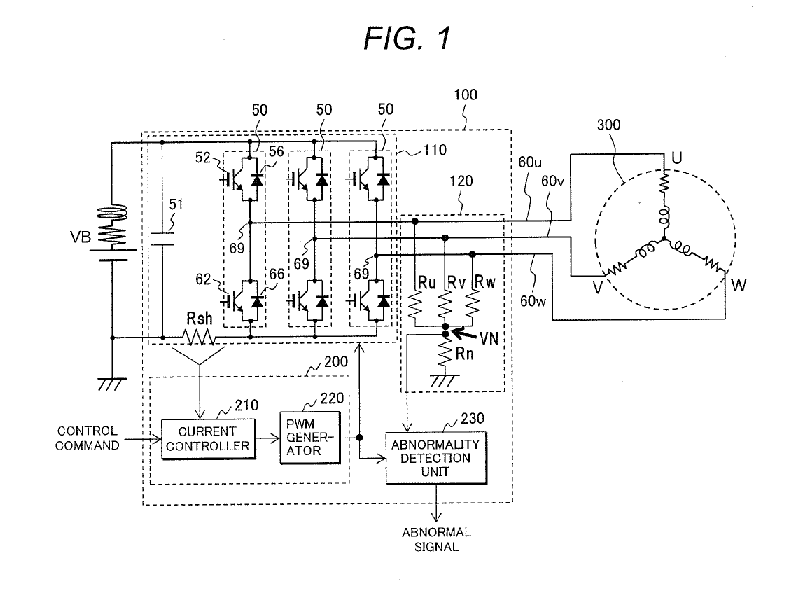

FIG. 1 is a diagram showing the configuration of an electric motor drive device according to a first embodiment of the present invention. The electric motor drive device 100 shown in FIG. 1 is used in, for example, a vehicle auxiliary system. The electric motor drive device 100 is connected to an electric motor 300 through output lines 60u, 60v, and 60w each provided with respect to each of U, V and W phases to drive the electric motor 300. The electric motor drive device 100 is equipped with a power conversion circuit 110, a virtual neutral point setting circuit 120, a control unit 200, and an abnormality detection unit 230. Incidentally, there are shown in FIG. 1, the electric motor drive device 100 and the electric motor 300 of the vehicle auxiliary system as configurations related to the present invention. Other mechanical parts which configure the vehicle auxiliary system are omitted.

The power conversion circuit 110 has series circuits 50 of upper and lower arms with respect to the respective phases U, V and W respectively. Each of the series circuits 50 is configured of a switching element 52 and a diode 56 corresponding to the upper arm, and a switching element 62 and a diode 66 corresponding to the lower arm. Each series circuit 50 is provided with an intermediate electrode 69 between the upper and lower arms. The intermediate electrodes 69 are respectively connected to the output lines 60u, 60v, and 60w. Thus, the switching elements 52 and 62 of the respective phases are respectively connected to the output lines for their corresponding phases, of the output lines 60u, 60v, and 60w. Incidentally, there are used as the switching elements 52 and 62, for example, a bipolar transistor, an insulated gate bipolar transistor (IGBT), a field effect transistor (FET), etc.

The electric motor 300 is a three-phase AC motor rotatably driven by being supplied with three-phase AC power. There are used as the electric motor 300, for example, a permanent magnet synchronous motor, an induction motor, a synchronous reactance motor, etc. The electric motor 300 has windings corresponding to the U, V and W phases respectively. The respective series circuits 50 of the power conversion circuit 110 are electrically connected to the phase windings of the electric motor 300 through the output lines 60u, 60v, and 60w at the intermediate electrodes 69. Incidentally, the output lines 60u, 60v, and 60w respectively include portions from the intermediate electrodes 69 of the series circuits 50 to the phase windings of the electric motor 300.

The power conversion circuit 110 is connected to a battery power supply VB which serves as a DC voltage source. In the power conversion circuit 110, a collector electrode of each switching element 52 of the upper arm is electrically connected to the positive electrode side of the battery power supply VB. An emitter electrode of each switching element 62 of the lower arm is electrically connected to the negative electrode side of the battery power supply VB through a shunt resistor Rsh. The switching elements 52 and 62 of the upper and lower arms are driven and controlled by ON/OFF signals (PWM signals) outputted from the control unit 200, so that a DC voltage Vdc outputted from the battery power supply VB is converted into a variable-voltage variable-frequency three-phase AC voltage, followed by being applied to the electric motor 300. As a result, the electric motor 300 is rotatably driven.

The power conversion circuit 110 further has a smoothing capacitor 51 for suppressing voltage fluctuations due to the operations of the switching elements 52 and 62 of the upper and lower arms. The smoothing capacitor 51 is connected to the battery power supply VB in parallel with the series circuits 50 of the upper and lower arms for the respective phases.

The virtual neutral point setting circuit 120 is a circuit for setting a virtual neutral point VN potentially equivalent to the neutral point of the electric motor 300. The virtual neutral point setting circuit 120 is connected to the output lines 60u, 60v, and 60w. In the present embodiment, the ground faults of the output lines 60u, 60v, and 60w can be detected by monitoring the voltage of the virtual neutral point VN. This point will be described in detail later.

The control unit 200 is a part for controlling the operations of the switching elements 52 and 62 of the power conversion circuit 110 and has a current controller 210 and a PWM generator 220.

The current controller 210 performs current control for controlling the torque and rotational speed of the electric motor 300, based on a control command inputted from outside. Described specifically, the current controller 210 determines current detection values (Iu, Iv, and Iw) of three phases, based on a DC current value Idc detected by the shunt resistor Rsh provided on a DC bus to connect between the minus output side of the battery power supply VB and each series circuit 50 of the upper and lower arms, and PWM pulse patterns generated by the PWM generator 220. The current controller 210 generates voltage command values (Vu*, Vv*, and Vw*) of the three phases for each constant PWM period and outputs the same to the PWM generator 220 in such a manner that an error between each of the current detection values (Iu, Iv, and Iw) and a current instruction value based on the inputted control command becomes 0. At this time, there is no problem even if without using the current detection values (Iu, Iv, and Iw) of the three phases as they are, for example, the rotational position θ of the electric motor 300 is determined, and current detection values (Id and Iq) obtained by dq-converting the three-phase current detection values (Iu, Iv, and Iw) based on the rotational position θ are used.

Based on the voltage command values (Vu*, Vv*, and Vw*) outputted from the current controller 210, the PWM generator 220 determines the pulse widths of the phases equivalent to these voltage command values, based on the voltage command values (Vu*, Vv*, and Vw*). Then, the PWM generator 220 generates PWM-modulated drive signals (PWM signals) in accordance with the determined pulse widths and outputs the same to the power conversion circuit 110. In response to the PWM signals, the switching elements 52 and 62 of the power conversion circuit 110 are respectively turned ON or OFF for each PWM period to thereby adjust the voltages to be outputted to the electric motor 300.

The abnormality detection unit 230 detects each voltage value of the virtual neutral point VN set by the virtual neutral point setting circuit 120 and detects an abnormality, based on the result of its detection where the abnormality occurs in each of the output lines 60u, 60v, and 60w. Incidentally, a specific detecting method at this time will be described in detail later. When the occurrence of the abnormality is detected, the abnormality detection unit 230 outputs a predetermined abnormal signal and is operated to perform notifications such as lighting up an unillustrated warning lamp, etc.

### <Details of Virtual Neutral Point Setting Circuit and Abnormality Detection Unit>

A description will next be made about the details of the virtual neutral point setting circuit 120 and the abnormality detection unit 230, which are the features of the present invention. As described above, the virtual neutral point setting circuit 120 is the circuit for setting the virtual neutral point VN potentially equivalent to the neutral point of the electric motor 300. Specifically, as illustrated in FIG. 1, the virtual neutral point setting circuit 120 is configured by connecting resistors Ru, Rv, and Rw to the output lines 60u, 60v, and 60w connected between the intermediate electrodes 69 of the power conversion circuit 110 and the windings of the electric motor 300, respectively and connecting these resistors to the ground through a ground resistor Rn. Thus, the average potential of the output lines 60u, 60v, and 60w of the phases can be detected by setting the virtual neutral point VN between the resistors Ru, Rv, and Rw and the ground resistor Rn and detecting the voltage values (voltage divided values) of the virtual neutral point VN.

Incidentally, since the voltage of the battery power supply VB is generally as low as about 12 volts in the vehicle auxiliary system, there is no problem even if the virtual neutral point setting circuit 120 is configured by directly connecting the resistors Ru, Rv, and Rw to the output lines 60u, 60v, and 60w of the phases as shown in FIG. 1. However, in the case of a system which drives a wheel driving electric motor at a relatively high voltage as in a drive system of a hybrid electric vehicle, for example, the virtual neutral point setting circuit 120 is desirably configured such that each voltage value of the virtual neutral point VN can be indirectly detected using a differential voltage detection circuit, an insulation transformer, etc.

Here, a voltage division ratio between the resistors in the virtual neutral point setting circuit 120 is preferably set in such a manner that each voltage value of the virtual neutral point VN falls within a range of a voltage level that can be processed by the abnormality detection unit 230. For example, if the input level of an A/D converter provided in the abnormality detection unit 230 falls within a range of 0 to 5V where the output from the virtual neutral point setting circuit 230 is digitally processed at the abnormality detection unit 230, the division ratio of the virtual neutral point setting circuit 120 is set in such a manner that the voltage value of the virtual neutral point VN falls within this range. Alternatively, the voltage value of the virtual neutral point VN may be corrected and used by being standardized to a voltage level processable by the abnormality detection unit 230. Incidentally, when each voltage value of the virtual neutral point VN is inputted from the virtual neutral point setting circuit 120 to the abnormality detection unit 230, there is no problem even if it is amplified by an operational amplifier or a voltage obtained by impedance conversion is applied.

The abnormality detection unit 230 detects the voltage value of the virtual neutral point VN set by the virtual neutral point setting circuit 120 in the above-described manner and compares a tilt (time differential value) of a temporal change in its detected value with a predetermined threshold value. Thus, when the ground fault occurs in each of the output lines 60u, 60v, and 60w, it is detected as an abnormality of each of the output lines 60u, 60v, and 60w.

The above threshold value for detecting the ground fault by the abnormality detection unit 230 can be set based on the amount of current flowing through the smoothing capacitor 51. For example, the threshold value of the abnormality detection unit 230 is defined based on the amount of the current flowing from the battery power supply VB to the smoothing capacitor 51 when all the switching elements 52 each corresponding to the upper arm are in an ON state. Specifically, the threshold value can be adjusted based on the voltage Vdc of the battery power supply VB and the current value flowing through the shunt resistor Rsh.

Incidentally, when the amount of the current flowing from the battery power supply VB to the smoothing capacitor 51 is sufficiently small, the processing of the abnormality detection unit 230 can be simplified by setting the threshold value to 0. Alternatively, the amount of the current flowing from the battery power supply VB to the smoothing capacitor 51 is estimated, and the threshold value may be set based on the estimated value. In the present embodiment, the former case will be described.

### <Description of Output Voltage Vectors>

A description will now be made about the output voltage vectors of the power conversion circuit 110. The output voltages of the power conversion circuit 110 can be represented by classification into eight types of output voltage vectors of V0 to V7 shown below according to the state of switching of the individual switching elements 52 and 62. Hereinafter, in the order of the U, V, and W phases, the turning ON of each switching element 52 of the upper arm and the turning OFF of each switching element 62 of the lower arm are expressed in “1”, and the turning OFF of each switching element 52 of the upper arm and the turning ON of each switching element 62 of the lower arm are expressed in “0”:
V0=(0, 0, 0)
V1=(1, 0, 0)
V2=(1, 1, 0)
V3=(0, 1, 0)
V4=(0, 1, 1)
V5=(0, 0, 1)
V6=(1, 0, 1) and
V7=(1, 1, 1).

The combinations of the output voltages from the power conversion circuit 110 to the output lines 60u, 60v, and 60w change among the above output voltage vectors of V0 to V7 according to the pulse patterns of the PWM signals outputted from the PWM generator 220. That is, 0 or the voltage Vdc of the battery power supply VB is supplied from the power conversion circuit 110 to the output lines 60u, 60v, and 60w in accordance with the output voltage vectors of V0 to V7 determined based on the pulse patterns of the PWM signals, respectively. Incidentally, a V0 vector at which all the output voltages of three phases become 0, and a V7 vector at which all the output voltages of three phases become Vdc are respectively called a zero vector.

### <Changes in Voltage at the Occurrence of Ground Fault>

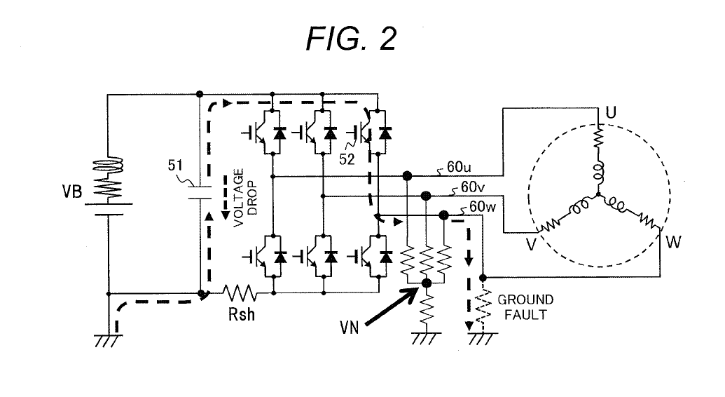

A description will next be made about changes in voltage at the occurrence of a ground fault. FIG. 2 is a circuit diagram showing one example of a ground fault phenomenon.

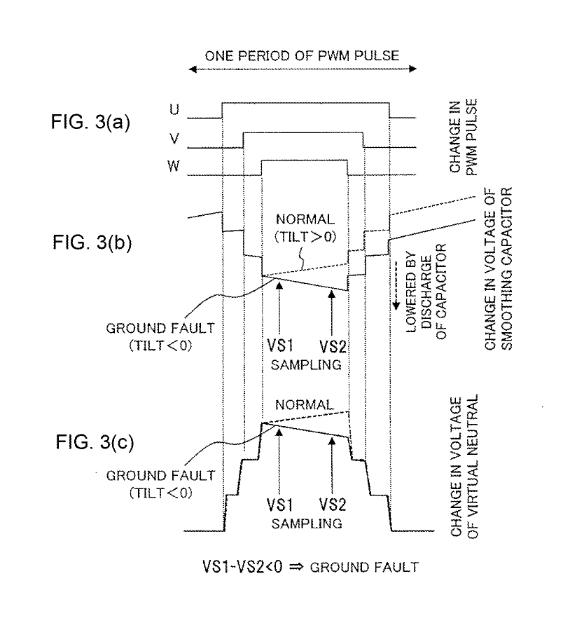

Assume that as shown in the circuit diagram of FIG. 2, a ground fault occurs in, for example, the W-phase output line 60w of the output lines 60u, 60v, and 60w. In this case, when the switching element 52 corresponding to the upper arm of the W phase is brought to an ON state, a ground fault current flows through a path indicated by a dashed arrow in the drawing. That is, since the current flows through the smoothing capacitor 51, the voltage across the smoothing capacitor 51 is decreased. FIGS. 3(a), 3(b), and 3(c) are a diagram showing the manner of changes in the voltages of the smoothing capacitor 51 and the virtual neutral point VN at the occurrence of the ground fault. When the pulse patterns of the PWM signals of the U, V, and W phases inputted to the power conversion circuit 110 respectively change as shown in FIG. 3(a) where the ground fault occurs in the output line 60w of the W phase as described above, the voltage across the smoothing capacitor 51 changes as shown in FIG. 3(b). That is, when the PWM signals of the U, V, and W phases become high in level in order, and the corresponding switching elements 52 of upper arms are respectively turned ON, the output voltage vectors of the power conversion circuit 110 are sequentially changed to V1, V2, and V7. Thus, the supply of power from the battery power supply VB to the electric motor 300 via the output lines 60u, 60v, and 60w in this order is performed, and correspondingly the voltage across the smoothing capacitor 51 is gradually lowered.

When the upper-arm switching elements 52 of the U, V, and W phases are all turned ON, the output voltage vectors of the power conversion circuit 110 become the V7 vector. At this time, the smoothing capacitor 51 is charged by the battery power supply VB if normal free of the occurrence of the ground fault. Therefore, as indicated by a broken line in FIG. 3(b), the voltage across the smoothing capacitor 51 gradually increases according to the lapse of time, and its tilt becomes larger than 0. When, however, such a ground fault as shown in FIG. 2 occurs, the smoothing capacitor 51 is discharged by the flow of the ground fault current through the smoothing capacitor 51. Therefore, as indicated by a solid line in FIG. 3(b), the voltage across the smoothing capacitor 51 gradually decreases according to the lapse of time, and its tilt becomes smaller than 0.

On the other hand, the voltage of the virtual neutral point VN changes as shown in FIG. 3(c). That is, when the PWM signals of the U, V, and W phases are made high in level in order so that their corresponding switching elements 52 of the upper arms are turned ON, the output voltage vectors of the power conversion circuit 110 are sequentially changed to V1, V2 and V7. Thus, power is supplied from the battery power supply VB to the electric motor 300 via the output lines 60u, 60v, and 60w in this order, and correspondingly the voltage of the virtual neutral point VN rises stepwise.

When all the switching elements 52 of the U, V, and W phase are turned ON, the output voltage vectors of the power conversion circuit 110 become the V7 vector. If normal free of the occurrence of the ground fault at this time, the smoothing capacitor 51 is charged by the battery power supply VB as described above. Therefore, as illustrated by a broken line in FIG. 3(c), the voltage of the virtual neutral point VN gradually increases according to the lapse of time, and its tilt becomes larger than 0. When, however, such a ground fault as shown in FIG. 2 occurs, the smoothing capacitor 51 is discharged by the flow of the ground fault current through the smoothing capacitor 51 as described above. Therefore, as indicated by a solid line in FIG. 3(c), the voltage of the virtual neutral point VN gradually decreases according to the lapse of time, and its tilt becomes smaller than 0.

In the present invention, the occurrence of the ground fault in each of the output lines 60u, 60v, and 60w is detected by observing the manner of the change in the voltage of the smoothing capacitor 51 or the virtual neutral point VN at the above-described occurrence of ground fault by means of the abnormality detection unit 230. That is, the abnormality detection unit 230 detects, as a value related to the insulation state of each of the output lines 60u, 60v, and 60w, the value of the voltage across the smoothing capacitor 51 when each output voltage vector of the power conversion circuit 110 is of the V7 vector within the PWM period, or the value of the voltage of the virtual neutral point VN, and determines the tilt of a temporal change in the detected value . Specifically, as shown in FIGS. 3(a), 3(b), and 3(c), for example, the period of the V7 vector is defined as a sampling period, and the value of the voltage across the smoothing capacitor 51 or the voltage value of the virtual neutral point VN is detected at each of sampling points of VS1 and VS2 set within the sampling period. Then, the difference between these detection values is determined, so that the tilt of a temporal change in the detected value can be obtained. At this time, the number of sampling points may be set to 3 or more. It is determined whether or not the so-obtained tilt of temporal change in the detected value is greater than or equal to a predetermined threshold value (e.g., 0). If it is less than the threshold value, the ground fault can be determined to have been generated in any of the output lines 60u, 60v, and 60w.

Incidentally, in the present embodiment, a description will be made about the case where the voltage value of the virtual neutral point VN is detected, and the ground fault is detected based on the tilt of the temporal change in its detected value. Another case, i.e., the case where the value of the voltage across the smoothing capacitor 51 is detected, and a ground fault is detected based on the tilt of a temporal change in its detected value, will be described in detail later according to a second embodiment.

### <Outline of the Present Embodiment>

In the present embodiment as described above, when the temporal change in the voltage value of the virtual neutral point VN detected when each output voltage vector of the power conversion circuit 110 determined depending on the pulse pattern of each PWM signal is of the V7 vector falls below the predetermined threshold value, the ground fault is determined to have occurred. That is, since the voltage value of the virtual neutral point VN which appears in the process of the operation of the electric motor 300 becomes equal to the value of the voltage across the smoothing capacitor 51 in the state of the V7 vector, the insulation states of the output lines 60u, 60v, and 60w are determined as to whether to be normal by comparing the tilt of the temporal change in the voltage value with the predetermined threshold value in the present embodiment.

Incidentally, when the output voltage vectors of the power conversion circuit 110 are of the V0 vector, all the output voltages of three phases are 0 volts and hence the voltage value of the virtual neutral point VN becomes 0. Accordingly, when the ground fault is made at the V0 vector, this is not targeted for detection. On the other hand, since all the output voltages of three phases are of the DC voltage Vdc of the battery power supply VB when the output voltage vectors of the power conversion circuit 110 are of the V7 vector, the voltage value of the virtual neutral point VN becomes Vdc.

### <Abnormality Detection Processing>

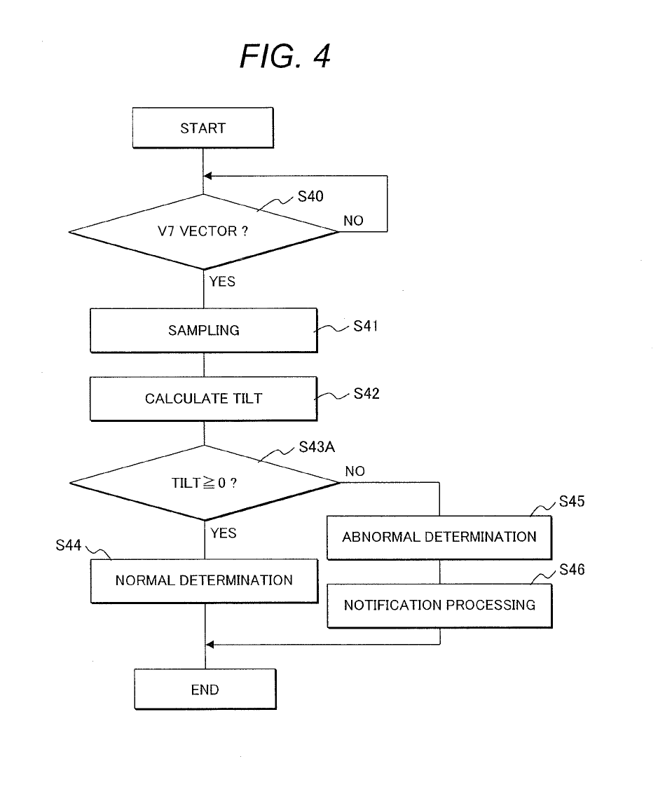

The ground fault determination described above is executed by the abnormality detection processing performed at the abnormality detection unit 230. FIG. 4 is a diagram showing a control flow of the abnormality detection processing according to the first embodiment of the present invention. The abnormality detection unit 230 performs the abnormality detection processing by executing the control flow shown in FIG. 4 for each predetermined period.

In Step S40, the abnormality detection unit 230 determines whether or not the output voltage vector of the power conversion circuit 110 is of the V7 vector. If it is determined to be the V7 vector, the abnormality detection unit 230 starts processing of Step S41 and subsequent Steps.

In Step S41, the abnormality detection unit 230 samples the voltage value of the virtual neutral point VN by twice or a predetermined number of times greater than that. Thus, the voltage value of the virtual neutral point VN set by the virtual neutral point setting circuit 120 is detected plural times as values related to the insulation states of the output lines 60u, 60v, and 60w during a sampling period in which all the switching elements 52 corresponding to the upper arms of the power conversion circuit 110 within the PWM period.

In Step S42, the abnormality detection unit 230 calculates the tilt (time differential value) of each voltage value of the virtual neutral point VN sampled in Step S41. That is, the abnormality detection unit 230 calculates the tilt of the temporal change in the voltage detection value of the virtual neutral point VN when all the switching elements 52 corresponding to the upper arms are in the ON state at the power conversion circuit 110.

In Step S43A, the abnormality detection unit 230 compares the tilt calculated in Step S42 with 0 as the threshold value and determines whether the tilt is greater than or equal to 0. As a result, the abnormality detection unit 230 proceeds to Step S44 if the tilt is greater than or equal to 0, and proceeds to Step S45 if the tilt is less than 0.

In Step S44, the abnormality detection unit 230 determines that no ground fault is generated in the output lines 60u, 60v, and 60w, and the state of insulation of each of the output lines 60u, 60v, and 60w is normal. After Step S44 is executed, the abnormality detection unit 230 completes the abnormality detection processing.

In Step S45, the abnormality detection unit 230 determines that the insulation state of any of the output lines 60u, 60v, and 60w is abnormal. Thus, the abnormality detection unit 230 determines that at least any one of the output lines 60u, 60v, and 60w has been grounded, and detects the ground fault thereof.

In Step S46, the abnormality detection unit 230 notifies that the ground fault has been detected in Step S45. For example, the occurrence of the ground fault is notified by outputting a predetermined abnormal signal and lighting up the unillustrated warning lamp. After Step S46 is executed, the abnormality detection unit 230 finishes the abnormality detection processing.

As described above, in the present embodiment, the voltage value of the virtual neutral point VN is detected according to the output voltage vector defined by the pulse pattern of each PWM signal. When the tilt of the temporal change in the detected voltage value is not greater than the predetermined value, the grounding abnormality is determined to have occurred. Therefore, highly reliable abnormality detection is enabled.

According to the first embodiment of the present invention described above, the following operative effects are brought about:

(1) The electric motor drive device 100 is connected to the electric motor 300 via the output lines 60u, 60v, and 60w of the phases to drive the electric motor 300. The electric motor drive device 100 is equipped with the switching elements 52 and 62 which are respectively connected to the output lines 60u, 60v, and 60w and correspond to the upper and lower arms of the phases, the control unit 200 which controls the operations of the switching elements 52 and 62, the smoothing capacitor 51 connected in parallel with the series circuits 50 of the upper and lower arms of the phases, and the abnormality detection unit 230. The abnormality detection unit 230 detects the value related to the insulation state of each of the output lines 60u, 60v, and 60w (Step S41) and detects the ground fault of each of the output lines 60u, 60v, and 60w, based on the tilt of the temporal change in its detected value (Steps S42, S43A, S45). Doing this enables the ground fault to be detected accurately regardless of the degree of modulation.

(2) The electric motor drive device 100 is further equipped with the virtual neutral point setting circuit 120 which sets the virtual neutral point VN potentially equivalent to the neutral point of the electric motor 300. In Step S41, the abnormality detection unit 230 detects the voltage value of the virtual neutral point VN as the value related to the insulation state of each of the output lines 60u, 60v, and 60w. By doing in this way, the ground fault can be accurately detected by obtaining the value appropriately indicating the insulation state of each of the output lines 60u, 60v, and 60w.

(3) The abnormality detection unit 230 determines whether or not the tilt of the temporal change in the detection value when all the switching elements 52 corresponding to the upper arms are in the ON state is less than the predetermined threshold value (Step S43A). When it is less than the threshold value, the abnormality detection unit 230 determines that the output line 60u, 60v or 60w has been grounded (Step S45). Doing in this way makes it possible to easily and reliably determine whether or not the output line 60u, 60v or 60w is grounded.

(4) The control unit 200 controls the operations of the switching elements 52 and 62 for each constant PWM period. The abnormality detection unit 230 executes the processing of Step S41 during the sampling period in which all the switching elements 52 corresponding to the upper arms are in the ON state within the PWM period, and detects the values related to the insulation states of the output lines 60u, 60v, and 60w plural times. By doing in this way, it is possible to reliably detect the values necessary to calculate the tilt of the temporal change.

### Second Embodiment

A second embodiment of the present invention will next be described. The present embodiment will describe a case where the value of a voltage across the smoothing capacitor 51 is detected, and a ground fault is detected based on the tilt of a temporal change in its detected value.

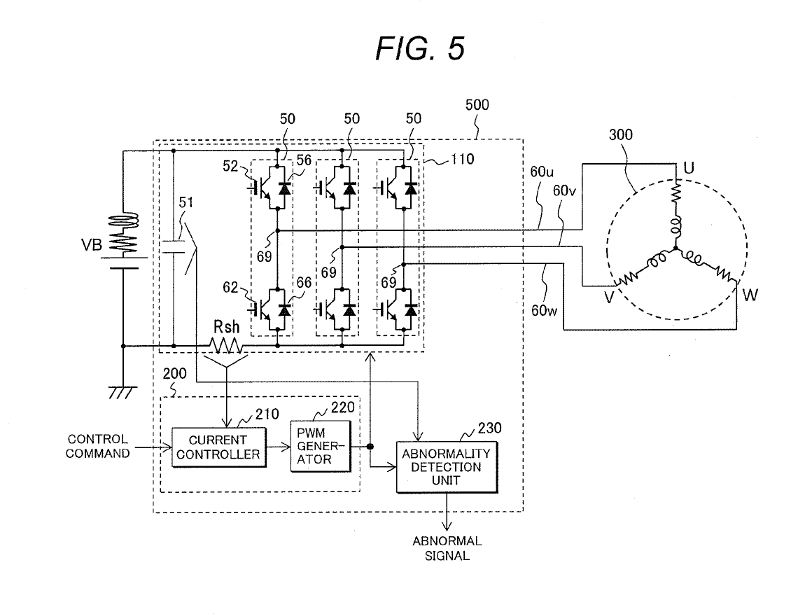

FIG. 5 is a diagram showing the configuration of an electric motor drive device according to the second embodiment of the present invention. The electric motor drive device 500 shown in FIG. 5 is different from the electric motor drive device 100 according to the first embodiment shown in FIG. 1 in that the virtual neutral point setting circuit 120 is not provided, and the abnormality detection unit 230 detects the voltage across the smoothing capacitor 51.

Incidentally, since the battery power supply VB is generally as low as about 12 volts in the vehicle auxiliary system, there is no problem even if as shown in FIG. 5, the voltage across the smoothing capacitor 51 is directly detected. However, in the case of the system which drives the wheel driving electric motor at a relatively high voltage as in the drive system of the hybrid electric vehicle, for example, it is desirable to indirectly detect the voltage across the smoothing capacitor 51 using the differential voltage detection circuit, the insulation transformer, etc.

Here, the result of detection of the voltage across the smoothing capacitor 51 is preferably set to fall within the range of a voltage level that can be processed by the abnormality detection unit 230. For example, if the input level of the A/D converter provided in the abnormality detection unit 230 falls within the range of 0 to 5V where the voltage across the smoothing capacitor 51 is digitally processed at the abnormality detection unit 230, the voltage across the smoothing capacitor 51 is divided so as to fall within this range. Thus, the value of the voltage across the smoothing capacitor 51 may be corrected and used by being standardized to a voltage level processable by the abnormality detection unit 230. Incidentally, when the voltage across the smoothing capacitor 51 is inputted to the abnormality detection unit 230, it may be amplified by the operational amplifier or the voltage obtained by impedance conversion may be applied thereto.

In the present embodiment, the occurrence of the ground fault in each of the output lines 60u, 60v, and 60w is detected by observing the manner of the change in the voltage of the smoothing capacitor 51 at the occurrence of such a ground fault as shown in FIG. 3(b). That is, when the temporal change in the value of the voltage across the smoothing capacitor 51, which is detected when the output voltage vector of the power conversion circuit 110 determined depending on the pulse pattern of each PWM signal is of the V7 vector, falls below the predetermined threshold value, the ground fault is determined to have occurred.

Specifically, in Step S41 of the control flow shown in FIG. 4, the abnormality detection unit 230 samples the value of the voltage across the smoothing capacitor 51 twice or by a predetermined number of times greater than that. Thus, the value of the voltage across the smoothing capacitor 51 is detected plural times as the values related to the insulation states of the output lines 60u, 60v, and 60w during the sampling period in which all the switching elements 52 corresponding to the upper arms of the power conversion circuit 110 are in the ON state within the PWM period. In the following Step S42, the abnormality detection unit 230 calculates the tilt (time differential value) of each voltage value across the smoothing capacitor 51, which is sampled in Step S41. That is, the abnormality detection unit 230 calculates the tilt of the temporal change in the value of the voltage across the smoothing capacitor 51 when all the switching elements 52 corresponding to the upper arms are in the ON state in the power conversion circuit 110. The second embodiment is similar to the first embodiment in terms of processing other than the above.

As described above, in the present embodiment, the value of the voltage across the smoothing capacitor 51 is detected according to the output voltage vector defined by the pulse pattern of each PWM signal. When the tilt of the temporal change in the detected voltage value is not greater than the predetermined value, the ground fault abnormality is determined to have occurred. Therefore, highly reliable abnormality detection is enabled.

According to the second embodiment of the present invention described above, the following operative effects (5) are further brought about in addition to (1), (3) and (4) described in the first embodiment.

(5) In Step S41, the abnormality detection unit 230 detects the value of the voltage across the smoothing capacitor 51 as the value related to the insulation state of each of the output lines 60u, 60v, and 60w. Since it is done in this way, the ground fault can be accurately detected by obtaining the value appropriately indicating the insulation state of each of the output lines 60u, 60v, and 60w.

### Third Embodiment

A third embodiment of the present invention will next be described. In the present embodiment, a description will be made about a case where the amount of current flowing into the smoothing capacitor 51 from the battery power supply VB is estimated, and a threshold value for ground fault determination is set based on the estimated value thereof.

Incidentally, since the configuration of the electric motor drive device according to the present embodiment is similar to either the configuration of FIG. 1 described in the first embodiment or the configuration of FIG. 5 described in the second embodiment, the description thereof will be omitted.

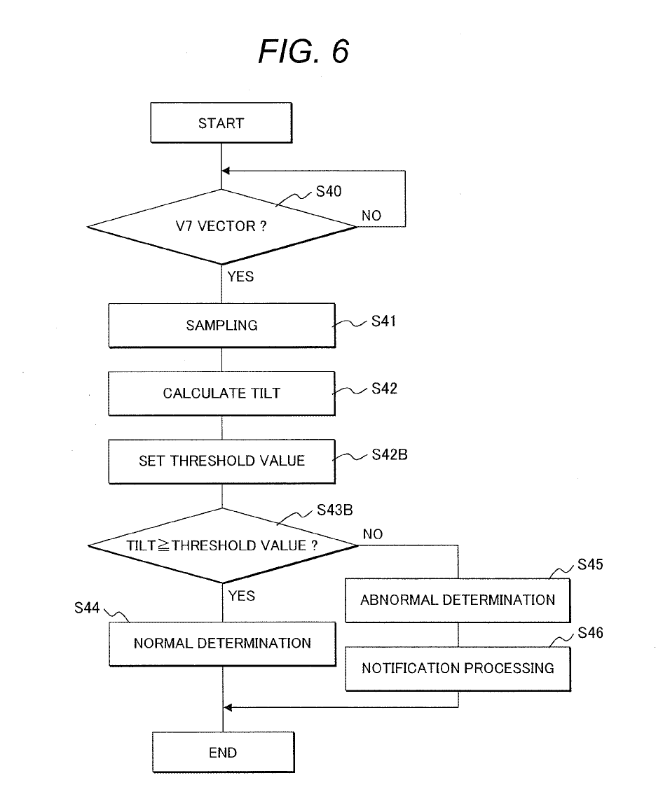

FIG. 6 is a diagram showing a control flow of abnormality detection processing according to the third embodiment of the present invention. In the present embodiment, the abnormality detection unit 230 executes the control flow shown in FIG. 6 for every predetermined period to carry out abnormality detection processing.

Incidentally, in the control flow of FIG. 6, processing steps which perform processing similar to the control flow in each of the first and second embodiments shown in FIG. 4, are respectively denoted by the same step numbers as those in FIG. 4. The description of the processing steps given the same step numbers as those in FIG. 4 will be omitted below unless otherwise required.

After the execution of Step S42, the abnormality detection unit 230 executes Step S42B. In Step S42B, the abnormality detection unit 230 sets a threshold value for use in the determination of the following Step S43B. Here, the threshold value can be set based on the amount of current flowing through the smoothing capacitor 51. For example, the amount of current of the smoothing capacitor 51 is estimated based on the voltage Vdc of the battery power supply VB and the value of current detected by the shunt resistor Rsh. Alternatively, the current amount of the smoothing capacitor 51 may be directly detected or may be calculated by detecting the amount of current output from the battery power supply VB and subtracting the current value detected by the shunt resistor Rsh from the detected value thereof.

After the current amount of the smoothing capacitor 51 has been determined in this way, the abnormality detection unit 230 sets a threshold value, based on the current amount. For example, if the current amount is less than a predetermined reference value, the threshold value is set to 0, whereas if the current amount is greater than or equal to the reference value, a predetermined threshold value Th (Th>0) is set. At this time, the threshold value Th may be changed according to the current amount. Thus, the threshold value can be adjusted according to the amount of current flowing through the smoothing capacitor 51.

After the execution of Step S42B, the abnormality detection unit 230 executes Step S43B. In Step S43B, the abnormality detection unit 230 compares the tilt calculated in Step S42 with the threshold value set in Step S42B and determines whether the tilt is greater than or equal to the threshold value. Incidentally, the tilt to be compared with the threshold value corresponds to the tilt of the temporal change in the voltage detection value of the virtual neutral point VN described in the first embodiment, or the tilt of the temporal change in the value of the voltage across the smoothing capacitor 51 described in the second embodiment. As a result, the abnormality detection unit 230 proceeds to Step S44 if the tilt is greater than or equal to the threshold value, and proceeds to Step S45 if it is less than the threshold value. After this, processing similar to FIG. 4 is executed.

According to the third embodiment of the present invention described above, the following operative effects (6) are further brought about in addition to (1) to (5) described in the first and second embodiments.

(6) The abnormality detection unit 230 sets a threshold value for use in the determination of Step S43B, based on the amount of current flowing through the smoothing capacitor 51 (Step S42B). Since the threshold value for its determination can be suitably adjusted in the above-described manner, it is possible to more accurately determine whether or not each of the output lines 60u, 60v, and 60w is grounded.

Incidentally, in each of the embodiments described above, there is a case where when the electric motor 300 is operated in a high load state and the duty of the PWM signal is in the vicinity of 100%, the sampling period during which the output voltage vector of the power conversion circuit 110 is of the V7 vector is short, and a plurality of sampling points cannot be obtained during the sampling period. Thus, in such a case, the timing provided to generate each PWM signal maybe adjusted by, such as, resetting a counter used in the generation of the PWM signal in midstream, in such a manner that a sufficient sampling period is obtained. For example, the timing provided to generate each PWM signal is adjusted in such a manner that the PWM pulse of each phase is outputted in accordance with the timing at which each of the voltage command values (Vu*, Vv*, Vw*) of the three phases becomes maximum. If done in this way, it is possible to determine the presence or absence of the occurrence of a ground fault by obtaining a sufficient sampling period for every electric angle of 60°.

Further, each of the embodiments described above has described the example in which when the negative determination that the tilt is less than 0 is made in Step S43A of FIG. 4, or when the negative determination that the tilt is less than the threshold value is made in Step S43B of FIG. 6, the state of insulation of the output line 60u, 60v or 60w is determined to be abnormal in the following Step S45 to thereby detect the ground fault. Without doing in this way, however, the ground fault may be detected when the negative determination is made continuously plural times in Step S43A or S43B. That is, when the tilt of the temporal change in the detection value at the time that all the switching elements 52 corresponding to the upper arms are in the ON state over the successive two or more PWM periods is less than the predetermined threshold value, the output line 60u, 60v or 60w may be determined to have been grounded. If done in this way, when a fluctuation in the voltage of the battery power supply VB and a ground fault phenomenon are suitably separated and the DC voltage Vdc of the battery power supply VB varies, it is possible to avoid it from being erroneously detected as a ground fault.

Further, in each of the embodiments described above, the abnormality detection unit 230 preferably executes the abnormality detection processing of FIG. 4 or 6 when the electric motor 300 is power-driven, and detects the ground fault of each of the output lines 60u, 60v, and 60w. If done in this way, when the ground fault occurs when power-driving the electric motor 300, it is possible to reliably detect the ground fault and avoid its danger.

The embodiments and the various modifications described above are only examples. The present invention is not limited to the contents of these unless the features of the invention are degraded. The present invention is not limited to the above-described embodiments, but can be modified in various ways within the scope not departing from the gist of the present invention.

What is claimed is:

1. An electric motor drive device connected to an electric motor through output lines of respective phases to drive the electric motor, comprising:
a plurality of switching elements respectively connected to the output lines, said switching elements corresponding to upper and lower arms of the phases;
a control unit controlling operations of the switching elements;
a smoothing capacitor connected in parallel with series circuits of the upper and lower arms of the phases; and
an abnormality detection unit which detects a value related to the state of insulation of each of the output lines and detects a ground fault of the output line, based on a tilt of a temporary change in the detected value.

2. The electric motor drive device according to claim 1, further comprising a virtual neutral point setting circuit which sets a virtual neutral point potentially equivalent to a neutral point of the electric motor,
wherein the abnormality detection unit detects a voltage value of the virtual neutral point as the value related to the state of insulation of the output line.

3. The electric motor drive device according to claim 1, wherein the abnormality detection unit detects a value of a voltage across the smoothing capacitor as the value related to the state of insulation of the output line.

4. The electric motor drive device according to claim 1, wherein when the tilt of the temporal change in the detected value when all the switching elements corresponding to the upper arms are in an ON state is less than a predetermined threshold value, the abnormality detection unit determines the output line to be grounded.

5. The electric motor drive device according to claim 4, wherein the abnormality detection unit sets the threshold value, based on an amount of current flowing through the smoothing capacitor.

6. The electric motor drive device according to claim 4, wherein the control unit controls the operations of the switching elements for each constant PWM period, and
wherein the abnormality detection unit detects the value related to the insulation state of the output line plural times during a period in which all the switching elements corresponding to the upper arms are in the ON state within the PWM period.

7. The electric motor drive device according to claim 6, wherein when the tilt of the temporal change in the detected value when all the switching elements corresponding to the upper arms are in the ON state over the PWM periods of successive two or more is less than the predetermined threshold value, the abnormality detection unit determines the output line to be grounded.

8. The electric motor drive device according to claim 1, wherein when the electric motor is power-driven, the abnormality detection unit detects the ground fault of the output line.
